(19) United States
(12) Patent Application Publication
(10) Pub. No.: US 2025/0136850 A1
(43) Pub. Date: May 1, 2025

(54) ADHESIVE FILM

(71) Applicant: HUECK FOLIEN GESELLSCHAFT M.B.H., Baumgartenberg (AT)

(72) Inventors: Georg AIGNER, Ennsdorf (AT); Waltraud RICKER, Ardagger Markt (AT)

(21) Appl. No.: 18/837,366

(22) PCT Filed: Feb. 10, 2023
(86) PCT No.: PCT/EP2023/053371

§ 371 Date: Aug. 9, 2024

(30) Foreign Application Priority Data
Feb. 14, 2022 (EP) 22156537.7

(51) Int. Cl. C09J 7/38; C09J 7/25; C09J 11/08

(52) U.S. Cl. CPC C09J 7/385; C09J 7/255; C09J 11/08; C09J 2301/124; C09J 2301/408; C09J 2301/414

(57) ABSTRACT

The invention relates to an adhesive foil, in particular made of plastics, comprising a coating with a lacquer film, characterized in that the lacquer film contains pigments with an average diameter which is larger than the layer thickness of the lacquer film.

The invention relates to an adhesive foil, in particular made of plastics, comprising a coating with a lacquer film.

Plastics are materials with comparatively low free surface energy and correspondingly low interfacial adhesion during adhesive bonding, coating, or printing. This can result in a failed adhesive bond with adhesive or weak sealing. This adhesion problem can also lead to the fact that the printed ink is rubbed off or the ink does not adhere to the surface.

In the case of adhesive tapes or adhesive labels, such as those used in the electronics industry, for example, it must be ensured, for example, that the adhesive detaches from the substrate with the adhesive tape, i.e., that no adhesive residues remain on the substrate that would impair the product.

In the case of removable adhesives, which are used for keep-fresh packaging of food, wet wipes, etc., it is also necessary for the adhesive to remain on the substrate, as otherwise the function would be lost.

Furthermore, double-sided adhesive tapes that are used for permanent adhesive bonding, such as for the adhesive bonding of components in the automotive industry, must have such good adhesion that peeling off is no longer possible.

However, standard foils cannot be used for the above-mentioned applications, as adhesive transfer cannot be prevented with these. However, good wettability of the surface alone does not effect good adhesion. It is therefore necessary to modify the foil surface. In order to be able to provide adhesive tapes and packaging materials with the required properties, for example, the free surface energy of the foil is often increased by pre-treatment. Common methods for plastic foils are plasma, corona, or flame treatment as well as the effect of oxidizing gases such as ozone or fluorine.

Another method used in the prior art to modify the surface energy of a foil is chemical treatment with trichloroacetic acid (TCA). Here, the foil is etched using TCA, as a result of which a molecular modification of the surface is achieved, which has an advantageous effect on the adhesion properties.

For example, WO 2018/011237 A1 discloses a method for producing a single-sided adhesive foil, wherein the support layer in the form of a polyester film (polyester terephthalate-PET), before bonding with the adhesive layer, is treated with, e.g., trichloroacetic acid in order to increase the surface energy of the polyester film.

However, treatment with TCA has the disadvantage that the PET foils become milky or matt when etched, which greatly impairs their appearance. In addition, only untreated foils, i.e., those without already existing coatings, e.g., with metal, can be treated.

A major problem with TCA modification, however, is the trichloroacetic acid itself, which is difficult to handle due to its highly corrosive effect and poses a safety risk to workers and the environment.

Another common method for improving the adhesive properties of foils is coating using an adhesion promoter or so-called primer.

In order to solve the problem of poor adhesion of the metal layer to the foil, EP 3 733 749 A1, for example, teaches to apply an adhesion promoter layer between the foil and the metallic layer, which consists of an aqueous lacquer system based on a self-crosslinking polymer and/or a polymer, e.g., polyurethane, which can be crosslinked with a hardener.

JP 2000053930 A describes a primer layer for an adhesive tape made of a polyethylene terephthalate (PET) foil, wherein the primer layer, which consists of a polyester-based resin, is formed between a layer of an adhesive based on urethane, acrylic or silicone and the PET foil.

JPS5269942A describes an adhesive tape which is given improved adhesion between the polyester carrier and a light-shielding paint layer by means of a primer layer, the primer being formed from a mixture of a vinylidene chloride copolymer with a polyurethane precondensate containing isocyanate groups.

The object of the invention is to improve the properties of adhesive foils, in particular made of plastics, without having to subject the foil surface to a costly modification or potentially harmful and environmentally hazardous treatment, such as etching with TCA, and also without having to apply an adhesion promoter layer with a specially suitable primer composition. In particular, an adhesive foil is to be provided which has improved adhesive properties and achieves higher adhesion values, especially in the case of adhesive coatings, so that no adhesive transfer takes place when the adhesive foil is used, for example, as adhesive tape.

This object is achieved according to the invention with an adhesive foil of the type mentioned at the beginning by the features of the independent claim 1. Advantageous further developments of the invention are the subject matter of the subclaims.

The subject matter of the invention is an adhesive foil, in particular made of plastics, comprising a coating with a lacquer film, which is characterized in that the lacquer film contains pigments with an average diameter which is larger than the layer thickness of the lacquer film.

Preferably, the diameter of the particles is in the range of 2.0-12 μm, in particular, the average diameter is 4-6 μm.

The fact that pigments, the average diameter of which is larger than the layer thickness of the lacquer film, are provided in the lacquer film effects an increase in the surface area of the layer or foil, which results in higher adhesion values.

According to a preferred embodiment, the weight proportion of the pigment in the lacquer film is 1-50%, preferably 10-30%, based on the non-volatile fraction (nfA) of the binder of the lacquer.

The pigments that can be used according to the invention are preferably selected from inorganic or organic pigments, with earths, minerals, metal effect pigments, white pigments, iron oxide pigments, zirconium silicates and polymeric pigments being particularly preferred among the inorganic pigments.

In a particularly preferred configuration of the invention, the pigment is a polyamide pigment, preferably PA66 or PA12.

According to another embodiment, the lacquer film with which the adhesive foil is coated is an adhesion promoter layer.

Adhesion promoters, also referred to as primers, are agents that improve the adhesion properties of surfaces. Adhesion promoters are used for surfaces and coatings that are subject to heavy loads or are difficult to adhere to in order to increase the adhesive strength of the substances to be applied in each case. Increased adhesive strength often also improves resistance to water and chemicals as well as corrosion protection. Adhesion promoters are used in particular in printing, coatings, and adhesive tapes.

An adhesion promoter layer is thus advantageously used to additionally strengthen the adhesion between the layers to be applied to the foil, e.g., adhesive, paint etc.

Preferably, the adhesion promoter of the adhesion promoter layer is an ethylene-acrylic acid (EAA) copolymer.

The invention is preferably applicable to foils selected from polyimide (PI), polypropylene (PP), monoaxially oriented polypropylene (MOPP), biaxially oriented polypropylene (BOPP), polyethylene (PE), polyphenylene sulfide (PPS), polyether ether ketone (PEEK), polyether ketone (PEK), polyethylene imide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), tetrafluoroethylene-perfluoro propyl vinyl ether fluoro copolymer (PFA), tetrafluoromethylene-perfluoro propyl vinyl ether fluoro copolymer (MFA), polyvinyl fluoride (PVF), polyvinylidene fluoride (PVDF), ethylene-tetrafluoroethylene-hexafluoropropylene fluoropolymer (EFEP), polymethyl methacrylate (PMMA), cellulose- or lignin-based plastics, polyhydroxyalkanoates (PHA), thermoplastic starch (TPS), polylactic acid (PLA), polycaprolactone (PCL), polybutylene succinate (PBS), polybutylene adipate terephthalate (PBAT) and/or mixtures and/or co-polymers of these materials and/or composites of paper or metal and these materials.

The plastic material of the foils can be recyclable or even be made from recycled material. In particular, it can also be made from renewable raw materials and be biodegradable and/or marine degradable.

Preferably, the invention is applied to a PET foil. With this type of plastic foil, the advantage of the invention comes into play in particular, since an adhesion improvement has so far generally been implemented by means of the disadvantageous TCA treatment of the polyester foil.

However, it is to be understood that the improved adhesion properties are obtainable according to the invention with any other type of (plastic) foil, in particular the materials mentioned above.

In a preferred embodiment of the invention, the adhesive foil has a coating with the lacquer film on both sides.

A further preferred embodiment of the invention is characterized in that the adhesive foil has a metallization layer, wherein the coating with the lacquer film is applied onto the metallization layer.

Since surface modifications such as TCA treatment cannot be applied to foils that already have layers, e.g., a metallization, it has been difficult to date to provide coated foils with good adhesion for further material layers, such as paint, adhesive, etc. The invention is now able to provide already coated foils with improved adhesive properties.

According to a particularly advantageous configuration of the invention, the tensile strength when applying a self-adhesive coating to the lacquer film (composite adhesion) is >6 N/15 mm.

The invention is explained in more detail below with reference to an example and the drawing. In the figures:

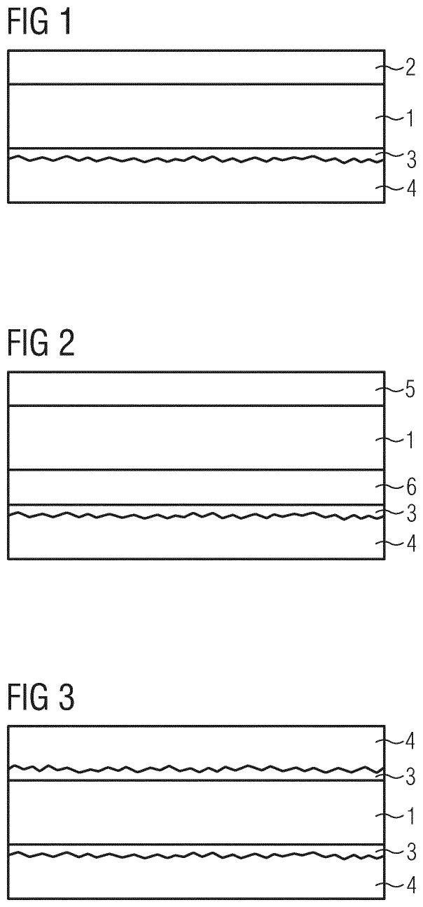

FIG. 1 shows the schematic structure of an adhesive tape material with an adhesive foil according to one embodiment of the invention,

FIG. 2 shows the schematic structure of a metallized label or freshness seal with an adhesive foil according to one embodiment of the invention, and

FIG. 3 shows the schematic structure of a double-sided adhesive tape with an adhesive foil according to one embodiment of the invention.

The layer structure of FIG. 1 shows a carrier foil 1, for example a PET foil, which is provided on one side with a siliconization or carbamate coating 2. The coating 2, also known as “release coating”, prevents the layers from sticking together when the foil is wound up in the form of a roll.

On the other side, the carrier foil 1 is coated with a lacquer film 3 which, in a preferred embodiment, can be an adhesion promoter or primer layer, preferably an ethylene-acrylic acid copolymer, in particular modified with polyurethane. Applying the lacquer onto the carrier foil 1 can be done using an anilox cylinder, for example, which ensures good flow of the lacquer layer. According to the invention, this lacquer film 3, whose application thickness or weight is, for example, 0.2 g/m², contains pigments which have an average diameter which is larger than the layer thickness of the lacquer film 3, namely in the range of 2.0-12 μm, in order to increase the surface area of the lacquer film layer. Preferred pigments are earths, minerals, metal effect pigments, white pigments, iron oxide pigments, zirconium silicates and polymeric pigments. Particularly preferred pigments are, for example, the polyamide pigments PA66 or PA12. The weight proportion of the pigment in the lacquer film is 1-50%, based on the non-volatile fraction of the binder of the lacquer.

A self-adhesive coating 4 is applied onto the lacquer film 3, which is based, for example, on conventional acrylate or hot-melt adhesives and is suitable for use in the electronics industry.

The layered structure of the label or freshness seal shown in FIG. 2 comprises, in addition to the carrier foil 1 which, in contrast to FIG. 1, does not have a silicone or carbamate coating on one side of the foil but is printed over the entire surface or partially with a paint layer 5, a metallization layer 6, e.g., a layer of Al to which the lacquer film 3 containing the pigments is applied. The metallization layer 6 can be deposited, for example, by PVD or CVD methods, by sputtering or electron beam evaporation and can be about 5-100 nm thick, depending on the specific use of the foil.

As in the adhesive tape structure shown in FIG. 1, there is a self-adhesive coating 4 on the lacquer film 3, which in this case contains an adhesive suitable for repeated removing and sticking of the label or freshness seal.

FIG. 3 shows a carrier foil 1 which, in contrast to the embodiment of the adhesive foil of FIG. 1, has a coating on both sides with the lacquer film or the adhesion promoter layer 3, to each of which an adhesive layer 4 is applied.

Such a double-sided adhesive tape can be used to permanently bond objects together, e.g., parts in the automotive industry, since the adhesive tape, due to the foil according to the invention, has better adhesion properties than conventional double-sided adhesive tapes.

### EXAMPLE

The adhesion values of an adhesive foil according to the invention were examined using a tensile testing machine (Zwick measuring method). The adhesive foil examined was a PET foil with the following lacquer film:
Coating: ethylene-acrylic acid copolymer (EAA), modified with polyurethane
Layer thickness: 0.2 g/m²
Pigment: Polyamide 66

The following test procedure was carried out to measure the adhesion properties of the adhesive foils:

On the adhesive foil to be tested, a piece of the prescribed adhesive film is glued to the test sample transverse to the running direction and firmly pressed in place with a roller. Thereafter, the adhesive film is evenly pulled off the adhesive foil to be tested at a pull-off angle of 90°.

The measurements carried out showed that the adhesion of the lacquer system of the adhesive foil was >6 N/15 mm. The adhesive of the adhesive film remained adhered to the lacquer film of the adhesive foil, which shows that the adhesion properties of the adhesive foil according to the invention are significantly improved compared to the adhesive foils of the prior art and that the adhesive foil can be advantageously used, for example, in an adhesive tape for the electronics industry.

1. An adhesive foil, in particular made of plastics, comprising a coating with a lacquer film, characterized in that the lacquer film contains pigments with an average diameter which is larger than the layer thickness of the lacquer film.

2. The adhesive foil according to claim 1, characterized in that the diameter of the particles is in the range of 2.0-12 μm, preferably, the average diameter is 4-6 μm.

3. The adhesive foil according to claim 1, characterized in that the weight proportion of the pigment in the lacquer film is 1-50%, preferably 10-30%, based on the non-volatile fraction (nfA) of the binder of the lacquer.

4. The adhesive foil according to claim 1, characterized in that the pigments are selected from inorganic or organic pigments.

5. The adhesive foil according to claim 1, characterized in that the inorganic pigments are selected from earths, minerals, metal effect pigments, white pigments, iron oxide pigments, zirconium silicates and polymeric pigments.

6. The adhesive foil according to claim 5, characterized in that the pigment is a polyamide pigment, preferably PA66 or PA12.

7. The adhesive foil according to claim 1, characterized in that the lacquer film is an adhesion promoter layer.

8. The adhesive foil according to claim 7, characterized in that the adhesion promoter of the adhesion promoter layer is an ethylene-acrylic acid copolymer.

9. The adhesive foil according to claim 1, characterized in that the foil is selected from polyimide (PI), polypropylene (PP), monoaxially oriented polypropylene (MOPP), biaxially oriented polypropylene (BOPP), polyethylene (PE), polyphenylene sulfide (PPS), polyether ether ketone (PEEK), polyether ketone (PEK), polyethylene imide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), tetrafluoroethylene-perfluoro propyl vinyl ether fluoro copolymer (PFA), tetrafluoromethylene-perfluoro propyl vinyl ether fluoro copolymer (MFA), polyvinyl fluoride (PVF), polyvinylidene fluoride (PVDF), ethylene-tetrafluoroethylene-hexafluoropropylene fluoropolymer (EFEP), polymethyl methacrylate (PMMA), cellulose- or lignin-based plastics, polyhydroxyalkanoates (PHA), thermoplastic starch (TPS), polylactic acid (PLA), polycaprolactone (PCL), polybutylene succinate (PBS), polybutylene adipate terephthalate (PBAT) and/or mixtures and/or co-polymers of these materials and/or composites of paper or metal and these materials.

10. The adhesive foil according to claim 9, characterized in that it is a PET foil.

11. The adhesive foil according to claim 1, characterized in that it has a coating with the lacquer film on both sides.

12. The adhesive foil according to claim 1, characterized in that it has a metallization layer, wherein the coating with the lacquer film is applied onto the metallization layer.

13. The adhesive foil according to claim 1, characterized in that the tensile strength when applying a self-adhesive coating to the lacquer film (composite adhesion) is >6 N/15 mm.
